(19) United States
(12) Patent Application Publication
(10) Pub. No.: US 2022/0371142 A1
(43) Pub. Date: Nov. 24, 2022

(54) MACHINE TOOL

(71) Applicant: SHIBAUR MACHINE CO., LTD., Tokyo (JP)

(72) Inventor: Atsushi TADA, Shizuoka (JP)

(73) Assignee: SHIBAUR MACHINE CO., LTD., Tokyo (JP)

(21) Appl. No.: 17/754,436

(22) PCT Filed: Jul. 8, 2020
(86) PCT No.: PCT/JP2020/026731

§ 371 Date: Apr. 1, 2022

(30) Foreign Application Priority Data
Oct. 3, 2019 (JP) 2019-182918

(51) Int. Cl. B23Q 15/12; B23Q 5/32; B23Q 17/09

(52) U.S. Cl. CPC B23Q 15/12; B23Q 5/32; B23Q 17/09; B23Q 2717/006

(57) ABSTRACT

A machine tool includes: an advancing/retracting drive device causing a main spindle to travel back and forth with respect to a milling shaft; a clamp device provided in the milling shaft and clamping the main spindle; a feeding control section controlling the advancing/retracting drive device and the clamp device; and a reaction force sensor detecting reaction force against the advancing/retracting drive device from the main spindle. The feeding control section performs: in an unclamped state where the main spindle is not clamped by the clamp device, advancing/retracting control by which the main spindle is moved to a designated feeding position by the advancing/retracting drive device; and in a clamped state where the main spindle is clamped by the clamp device, reaction force servo control by which the advancing/retracting drive device is operated in a direction in which the reaction force detected by the reaction force sensor becomes small.

### CROSS-REFERENCE TO RELATED APPLICATIONS

This application is a U.S. National Stage of International Application No. PCT/JP2020/026731 filed Jul. 8, 2020, which Claims Priority from Japanese Patent Application No. 2019-182918 filed Oct. 3, 2019. All of the foregoing application are incorporated by reference in their entireties.

### TECHNICAL FIELD

The present invention relates to a machine tool with a feeding-type main spindle.

### BACKGROUND ART

In a machine tool, a tool is attached to an end of a main spindle rotatably supported by a main spindle head body. The main spindle head body is moved relative to a workpiece, making it possible to perform a machining process using the tool on any position of the workpiece.

Examples of a machine tool with a feeding-type main spindle include a boring facing-and-drilling machine (see, Patent Literature 1).

A machine tool with a feeding-type main spindle includes: a main spindle having an end to which a tool is attachable, the main spindle being rotatable around a central axis; a milling shaft housing the main spindle so that the main spindle is travelable back and forth in a direction of the central axis; a main spindle head body supporting the milling shaft so that the milling shaft is rotatable around the central axis; a rotation transmission mechanism configured to transmit rotation of the milling shaft to the main spindle; a main spindle drive motor provided in the main spindle head body and configured to drive the milling shaft to rotate; an advancing/retracting drive device provided in the main spindle head body to cause the main spindle to travel back and forth; and a clamp device provided in the milling shaft to clamp the main spindle.

A ball screw or the like is used as the advancing/retracting drive device. The ball screw is connected to an end of the main spindle opposite to the end attached with the tool, and the main spindle is moved by the ball screw in an axis direction. As the rotation transmission mechanism, an engagement mechanism that can transmit rotation of the milling shaft to the main spindle and that allows relative movement of the milling shaft in the axial direction, or a key and a key groove that are formed, for example, in an inner surface of the milling shaft and an outer surface of the main spindle to extend in the axis direction of the main spindle, is/are used.

The clamp device is provided at an end of the milling shaft near the attached tool. While clamping the main spindle (clamping state), the clamp device inhibits the runout of the axial center of the main spindle. The advancing/retracting drive device causes the main spindle to travel back and forth in a state where the clamping of the main spindle by the clamp device is released (unclamping state).

In such a machine tool with a feeding-type main spindle, through the rotary drive of the milling shaft by the main spindle drive motor, rotational force is transmitted to the main spindle via the rotation transmission mechanism. This rotates the tool attached to the main spindle, making it possible to perform machining on a workpiece.

A position of an end of the main spindle relative to the workpiece (i.e., accessibility of a tool position) can be changed by advancing or retracting the main spindle by the advancing/retracting drive device before machining. In machining, the runout of the main spindle is basically inhibited by clamping the main spindle in the vicinity of the end of the milling shaft using the clamp device.

In the above-described machine tool with the feeding-type main spindle, as the clamp device for clamping the main spindle, a mechanism clamping an entire circumference of the main spindle with a conical surface or the like (ring-shaped tapered surface) is used (see Patent Literature 2).

Specifically, a clamp device including: a clamp ring formed of an inner ring and an outer ring; a biasing member; and a release mechanism is used. The main spindle is inserted into the inner ring. A position of the inner ring in the central axis direction relative to the milling shaft is fixed. A conical surface of the outer ring can fit a conical surface of the inner ring. The bias member, such as a pack of disc springs, biases the outer ring in a direction in which the outer ring fits the inner ring. The release mechanism, such as a hydraulic piston, can drive in a release direction in which the fitting between the outer ring and the inner ring is released. In Patent Literature 2, a pair of clamp devices of the above-described clamp ring type is provided oppositely.

In a machine tool with a feeding-type main spindle that includes such a clamp device, a feeding operation of the main spindle can be performed after the release mechanism releases the clamping of the main spindle. Clamping the main spindle near an end of the milling shaft with the clamp device inhibits the runout of the advanced main spindle.

Machine tools adopt various measures in order to avoid deterioration in accuracy of the main spindle during operation due to thermal deformation. For example, a device configured to perform correction by measuring a temperature of a main spindle portion and calculating a thermal displacement amount (Patent Literature 3) and a device configured to perform correction by measuring thermal displacement of a main spindle or thermal displacement of a feeding mechanism (Patent Literature 4) are known.

In a machine tool with a feeding-type main spindle that includes the above-described clamp device, with the main spindle being clamped, thermal deformation affecting machining accuracy is caused in a limited section of the main spindle, a relatively short section ranging from the clamp device to the attached tool. Thus, when machining is performed with the main spindle being clamped, the thermal deformation of the main spindle is not likely to affect position accuracy of the attached tool. This makes it possible to minimize or omit the thermal deformation correction.

### CITATION LIST

### Patent Literature(s)

Patent Literature 1: JP 08-281501 A
Patent Literature 2: JP 05-44707 A
Patent Literature 3: JP 61-059860 B
Patent Literature 4: JP 07-266193 A

### SUMMARY OF THE INVENTION

### Problem(s) to be Solved by the Invention

In a machine tool with a feeding-type main spindle that includes the above-described clamp device, a part of the main spindle at an opposite side of the attached tool with respect to the clamp device does not affect position accuracy of the attached tool even with thermal deformation, as long as the main spindle is securely clamped. However, it is found out that the thermal deformation of the above part of the main spindle causes another problem on a feeding mechanism of the main spindle.

Specifically, an advancing/retracting drive device for feeding the main spindle is connected to the part of the main spindle at the opposite side of the attached tool with respect to the clamp device. The advancing/retracting drive device, which may be the above-described ball screw or the like, can move the main spindle back and forth by an advancing/retracting drive motor. The advancing/retracting drive device, however, has such a problem that displacement is reversely transmitted due to the thermal deformation of the main spindle, applying unnecessary torque to the advancing/retracting drive motor.

For example, it is assumed that the main spindle moved to a designated feeding position by the drive motor is stopped. In this state, when the main spindle is displaced by thermal deformation and shifted from the designated position, the drive motor that has detected the shift using position feedback generates drive torque in order to return the main spindle to the designated position. However, since the movement of the main spindle in a feeding direction is regulated by the clamp device, the advancing/retracting drive motor endlessly generates torque and consumes excessive current. Then, heat generated from the advancing/retracting drive motor is transmitted to the surroundings, further promoting the thermal deformation of the main spindle.

An object of the invention is to inhibit, in a machine tool with a feeding-type main spindle that includes a clamp device, unnecessary drive of an advancing/retracting drive device with the main spindle being clamped by the clamp device.

### Means for Solving the Problems

A machine tool according to an aspect of the invention includes: a main spindle having an end to which a tool is attachable, the main spindle being rotatable around a central axis; a milling shaft housing the main spindle so that the main spindle is travelable back and forth in a direction of the central axis; an advancing/retracting drive device configured to cause the main spindle to travel back and forth with respect to the milling shaft; a clamp device provided in the milling shaft and configured to clamp the main spindle; a feeding controller configured to control the advancing/retracting drive device and the clamp device; and a reaction force sensor configured to detect reaction force against the advancing/retracting drive device from the main spindle, in which the feeding controller is configured to perform: in an unclamped state where the main spindle is not clamped by the clamp device, advancing/retracting control by which the main spindle is moved to a designated feeding position by the advancing/retracting drive device; and in a clamped state where the main spindle is clamped by the clamp device, reaction force servo control by which the advancing/retracting drive device is operated in a direction in which the reaction force detected by the reaction force sensor becomes small.

In the above aspect of the invention, the clamp device is first put into the unclamping state. In this state, the feeding controller controls the advancing/retracting drive device to perform the advancing/retracting control so as to position the main spindle at a desired feeding position. Subsequently, the clamp device is put into the clamping state, and machining is performed by rotating the main spindle.

The feeding controller monitors reaction force to be detected by a reaction force sensor when the clamp device is put into the clamping state before machining. In machining with the main spindle, the main spindle extends or contracts in thermal deformation caused by heat, generating reaction force against the advancing/retracting drive device that is stationary at a desired feeding position. The reaction force is detected by the reaction force sensor, and the feeding controller moves the advancing/retracting drive device in a direction in which the reaction force of the main spindle becomes small. The thermal displacement of the main spindle caused is thus offset regardless of its amount. This eliminates unnecessary drive of the advancing/retracting drive device for canceling out the thermal displacement of the main spindle as well as unnecessary current consumption and heat generation for driving the advancing/retracting drive device.

As the advancing/retracting control by the advancing/retracting drive device, servo control can be used for the advancing/retracting drive motor of the advancing/retracting drive device. In the servo control, the main spindle is moved to a designated feeding position with reference to the position feedback of the main spindle. The position feedback of the main spindle may be calculated using displacement of any part of the advancing/retracting drive device or an angle position of a rotation axis of the advancing/retracting drive motor. As the advancing/retracting control in the feeding controller for cancelling out the thermal displacement of the main spindle, it is possible to use servo control referring to reaction force feedback from the reaction force sensor.

In the machine tool according to the aspect of the invention, the reaction force sensor is preferably a pressure sensor provided between a drive portion of the advancing/retracting drive device and a part of the main spindle driven by the drive portion.

In the above aspect of the invention, reaction force generated between the main spindle and the stationary advancing/retracting drive device when the main spindle extends or contracts in thermal displacement can be detected securely.

In the machine tool according to the aspect of the invention, the feeding controller is preferably configured to perform the reaction force servo control in a case where the reaction force exceeds a predetermined threshold value.

In the above aspect of the invention, the feeding controller performs the reaction force servo control when reaction force exceeds a predetermined threshold value. Thus, the reaction force servo control can be prevented when the reaction force does not exceed the predetermined threshold value (i.e., when the thermal displacement of the main spindle is small). This inhibits the reaction force servo control from being frequently performed when the thermal displacement of the main spindle is small.

In the machine tool according to the aspect of the invention, the reaction force sensor is preferably a strain gauge provided in a drive portion of the advancing/retracting drive device.

In the above aspect of the invention, reaction force from the main spindle can be detected based on a strain caused in the advancing/retracting drive device when the main spindle extends or contracts in thermal displacement. The strain gauge is easily set up in the machine tool. In particular, the structure using the strain gauge is simpler than a structure where the sensor is provided in a mechanism part of the advancing/retracting drive device and the main spindle.

In the machine tool according to the aspect of the invention, the reaction force sensor is preferably a current sensor configured to detect a current value of an advancing/retracting drive motor of the advancing/retracting drive device.

In the aspect of the invention, reaction force from the main spindle can be detected based on an increase in a load on the advancing/retracting drive motor and an increase in drive current, which are caused by the reaction force between the main spindle and the stationary advancing/retracting drive device when the main spindle extends or contracts in thermal displacement. The current sensor is easily set up in the machine tool. In particular, the structure using the current sensor is simpler than a structure where the sensor is provided in a mechanism part of the advancing/retracting drive device and the main spindle.

### BRIEF DESCRIPTION OF DRAWING(S)

FIG. 1 is a perspective view of a machine tool according to an exemplary embodiment of the invention.

FIG. 2 schematically shows a feeding-type main spindle of the exemplary embodiment.

FIG. 3 is a block diagram of a feeding controller of the exemplary embodiment.

FIG. 4 is a flowchart showing feeding control of the exemplary embodiment.

FIG. 5 schematically shows an operation according to the exemplary embodiment.

FIG. 6 is a schematic view of another exemplary embodiment of the invention.

FIG. 7 is a schematic view of still another exemplary embodiment of the invention.

### DESCRIPTION OF EMBODIMENT(S)

Referring to the drawings, an exemplary embodiment of the invention is explained below.

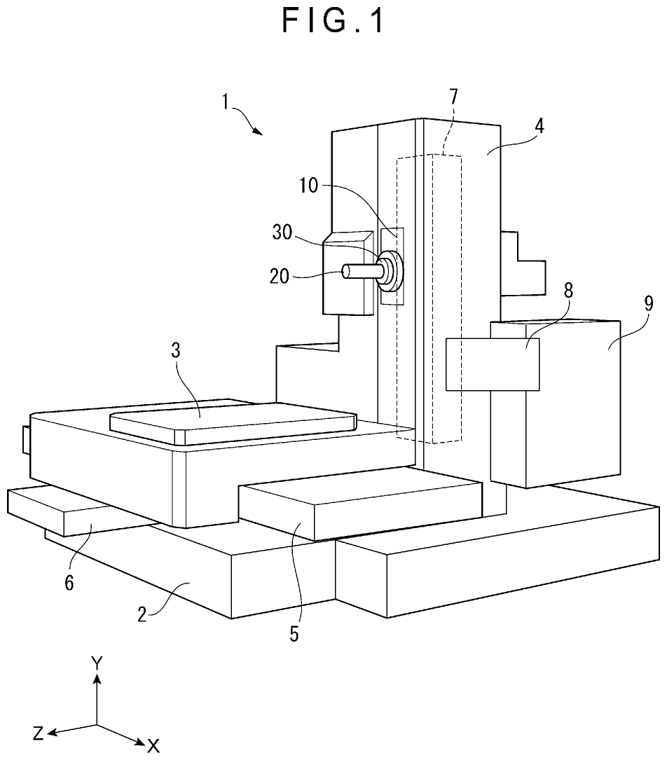

A machine tool 1 in FIG. 1 is a machine tool with a feeding-type main spindle according to the invention.

The machine tool 1 includes a table 3 and a column 4 on an upper surface of a bed 2.

The table 3 is travelable in horizontal X-axis and Z-axis directions by an X-axis travelling mechanism 5 and a Z-axis travelling mechanism 6. The X-axis and Z-axis directions intersect with each other.

The column 4 supports a main spindle head body 10. The main spindle head body 10 is supported by a Y-axis travelling mechanism 7 disposed in the column 4. The main spindle head body 10 can travel upward and downward along the column 4, that is, travelable in a Y-axis direction.

In order to control operation of relevant components, the machine tool 1 is provided with a controller 9 including an operation panel 8.

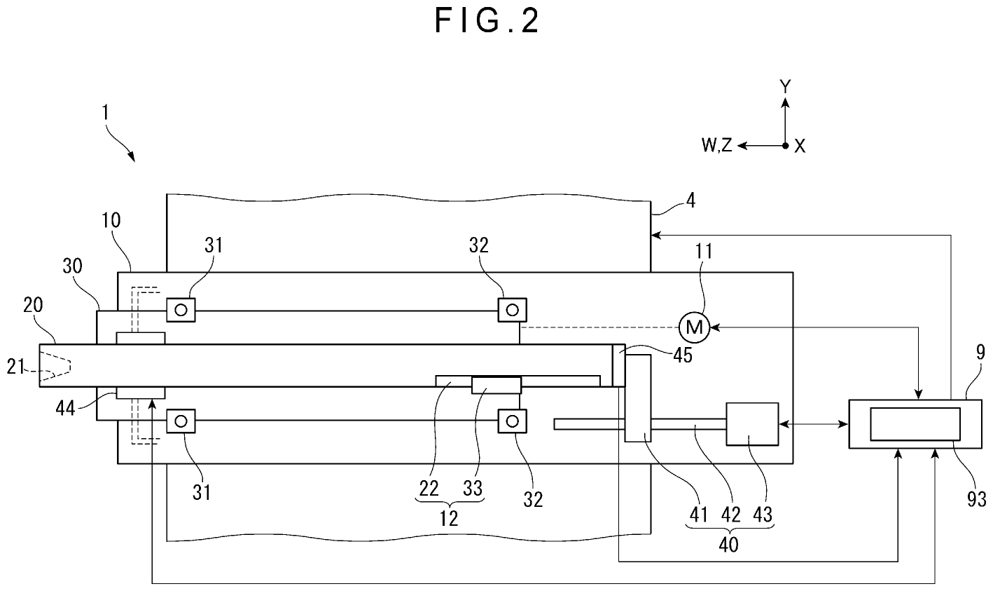

In FIG. 2, the main spindle head body 10 is provided with a feeding-type main spindle 20 and a milling shaft 30.

A first end of the main spindle 20 has a chuck 21 to which a tool is attached. The main spindle 20, which is housed in the milling shaft 30, is travelable back and forth with the main spindle 20 being coaxial with the center of the milling shaft 30, that is, with the central axes of the main spindle 20 and the shaft 30 aligned with each other. The central axes of the main spindle 20 and the milling shaft 30 are along the Z-axis direction of the machine tool 1.

The milling shaft 30 is rotatably supported by the main spindle head body 10 via bearings 31 and 32. The main spindle head body 10 is provided with a main spindle drive motor 11 that drives the milling shaft 30 to rotate. The main spindle drive motor 11 is connected to the milling shaft 30 via a transmission mechanism (not shown).

A rotation transmission mechanism 12 is disposed between the main spindle 20 and the milling shaft 30 to transmit rotation of the milling shaft 30 to the main spindle 20.

The rotation transmission mechanism 12 includes a key groove 22 and a key member 33. The key groove 22 is formed in an outer circumferential surface of the main spindle 20 to extend in a longitudinal direction. The key member 33 is fitted into the key groove 22 by being fixed to the milling shaft 30. By virtue of the rotation transmission mechanism 12, rotation can be transmitted between the milling shaft 30 and the main spindle 20, and the milling shaft 30 and the main spindle 20 can travel in the longitudinal direction.

The main spindle head body 10 includes an advancing/retracting drive device 40 that causes the main spindle 20 to travel back and forth in a central axis direction with respect to the milling shaft 30 and the main spindle head body 10.

The advancing/retracting drive device 40 includes a contact member 41, a feed screw mechanism 42, and an advancing/retracting drive motor 43. The contact member 41 comes into contact with a second end of the main spindle 20 opposite to the chuck 21. The feed screw mechanism 42 moves the contact member 41 in a longitudinal direction of the main spindle 20 (in the central axis direction). The main spindle 20 travels toward the first end thereof by being pushed by the contact member 41, which allows the main spindle 20 to advance from a first end of the milling shaft 30 (W-axis travel). The main spindle 20 can be retracted into the milling shaft 30 by moving the contact member 41 away from the second end of the main spindle 20 and applying force to the first end of the main spindle 20 or the like in a direction opposite to the advancing direction of the main spindle 20.

A reaction force sensor 45 is provided on the second end of the main spindle 20 at a position pushed by the contact member 41. The reaction force sensor 45 detects reaction force against the advancing/retracting drive device 40 from the main spindle 20. The reaction force sensor 45, which is a semiconductor pressure sensor or the like, can output an electrical signal depending on a pressure between the reaction force sensor 45 and the contact member 41.

In the machine tool 1 with the feeding-type main spindle, a workpiece put on the table 3 is subjected to machining with a suitable tool attached to the main spindle 20.

Machining for a workpiece is performed as follows: a relative position between the workpiece and the attached tool is controlled by the X-axis travelling mechanism 5, the Z-axis travelling mechanism 6, and the Y-axis travelling mechanism 7; the main spindle drive motor 11 drives the milling shaft 30 to rotate; and the tool attached to the main spindle 20 is rotated by rotational force transmitted to the main spindle 20 via the rotation transmission mechanism 12.

A deep portion of the workpiece can be subjected to machining by advancing the main spindle 20 in a W-axis direction by the advancing/retracting drive device 40.

A clamp device 44, which is disposed in the vicinity of the first end of the milling shaft 30, holds the advanced main spindle 20 to inhibit the runout of the milling shaft 30 and the main spindle 20.

The clamp device 44 may be a mechanism that clamps an entire circumference of the main spindle 20 with a conical surface (ring-shaped tapered surface). In a clamped state where the main spindle 20 is clamped by the clamp device 44, the clamp device 44 inhibits the runout of the axial center of the main spindle 20. The advancing/retracting drive device 40 causes the main spindle 20 to travel back and forth in a state where the main spindle 20 is not clamped by the clamp device 44 (unclamped state).

In the machine tool 1, the controller 9 controls the X-axis travelling mechanism 5, the Z-axis travelling mechanism 6, the Y-axis travelling mechanism 7, the main spindle drive motor 11, the advancing/retracting drive motor 43, and the clamp device 44.

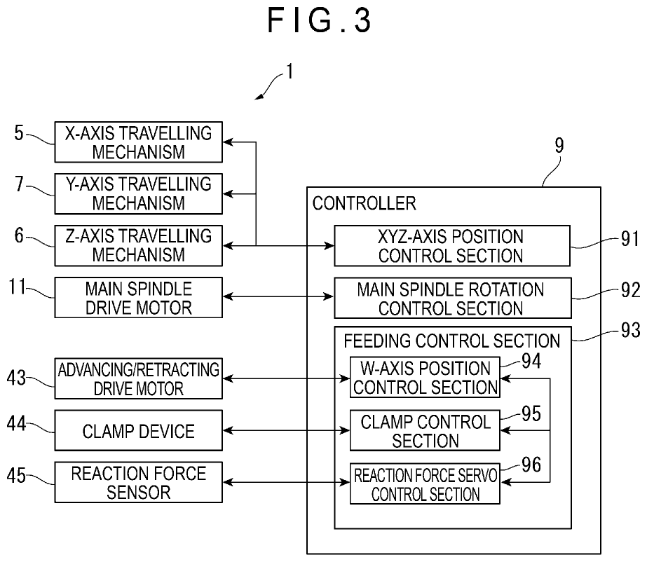

As shown in FIG. 3, the controller 9 includes an XYZ-axis position control section 91, a main spindle rotation control section 92, and a feeding control section 93.

The XYZ-axis position control section 91 controls the X-axis travelling mechanism 5, the Z-axis travelling mechanism 6, and the Y-axis travelling mechanism 7 based on a machining program to be run in the controller 9 to move the first end of the main spindle 20 attached with a tool to a predetermined XYZ-axis position.

The main spindle rotation control section 92 controls rotation of the main spindle drive motor 11 based on the machining program to be run in the controller 9, so that rotary cutting is performed with the tool attached to the main spindle 20.

The feeding control section 93 includes a W-axis position control section 94, a clamp control section 95, and a reaction force servo control section 96.

In response to a W-axis position change command (command for changing a feeding amount of the main spindle 20), the W-axis position control section 94 controls rotation of the advancing/retracting drive motor 43 of the advancing/retracting drive device 40 based on the machining program run in the controller 9, thus adjusting the W-axis position (feeding position) of the main spindle 20. When controlling the rotation of the advancing/retracting drive motor 43, the W-axis position control section 94 refers to W-axis position feedback of the advancing/retracting drive device 40 and performs a position servo operation for moving the advancing/retracting drive device 40 according to a difference between the feedback and a commanded W-axis position. The W-axis position feedback corresponds to a W-axis position of the main spindle 20 or the contact member 41. In the exemplary embodiment, the W-axis position control section 94 refers to a detection angle of an encoder of the advancing/retracting drive motor 43 and calculates a current W-axis position in an incremental manner from an initial value.

The clamp control section 95 switches the clamp device 44 between an unclamping state (for changing the feeding position of the main spindle 20) and a clamping state (for rotating the main spindle 20 in machining) based on the machining program run in the controller 9.

In the feeding control section 93, the W-axis position control section 94 cooperates with the clamp control section 95 to refer to a state of the clamp control section 95 (the clamping state or unclamping state of the clamp device 44). The W-axis position control section 94 can change the feeding position of the main spindle 20 by the advancing/retracting drive device 40 only in the unclamping state.

The reaction force servo control section 96 performs reaction force servo control for moving the advancing/retracting drive device 40 back and forth in a direction in which the reaction force detected by the reaction force sensor 45 becomes small. Specifically, the reaction force servo control section 96 refers to the reaction force detected by the reaction force sensor 45 with the main spindle 20 being clamped by the clamp device 44, and performs feedback control for operating the advancing/retracting drive device 40 to reduce the reaction force.

For example, when the main spindle 20 pushes the contact member 41 by being extended due to thermal deformation in machining, the pressing force is detected by the reaction force sensor 45. The reaction force servo control section 96 controls the advancing/retracting drive device 40 via the W-axis position control section 94 to move the contact member 41 backward in an extension direction of the main spindle 20.

Here, it is assumed that the contact member 41 maintains its original position. In this case, the contact member 41 in the original position is pushed and displaced by the main spindle 20 extended by thermal displacement. Such a displacement causes the W-axis position control section 94 to activate position feedback, so that a correction current passes through the advancing/retracting drive motor 43 to offset the displacement.

In contrast, by virtue of the backward movement of the contact member 41 by the reaction force servo control section 96, the position feedback by the W-axis position control section 94 is not activated even when the main spindle 20 is extended due to thermal displacement. Thus, no correction current passes through the advancing/retracting drive motor 43.

Such reaction force servo control is similarly performed on thermal deformation in a direction in which the main spindle 20 contracts without being limited to thermal deformation in the direction in which the main spindle 20 extends. That is, the reaction force servo control section 96 operates the advancing/retracting drive device 40 in a direction in which reaction force detected by the reaction force sensor 45 becomes small.

The reaction force servo control section 96 performs reaction force servo control when the reaction force obtained from the reaction force sensor 45 exceeds a predetermined threshold value. The predetermined threshold value is appropriately set in the reaction force servo control section 96 in advance based on thermal deformation characteristics of the main spindle 20.

In the machine tool 1 according to the exemplary embodiment, machining for a workpiece is performed by operating the X-axis travelling mechanism 5, Z-axis travelling mechanism 6, Y-axis travelling mechanism 7, and main spindle drive motor 11 in cooperation with each other under the control of the XYZ-axis position control section 91 and the main spindle rotation control section 92 based on the machining program for the controller 9.

Before machining or before the next machining, the feeding position of the main spindle 20 is adjusted under the control of the feeding control section 93. Specifically, the clamp device 44 is put into the unclamping state under the control of the clamp control section 95, the main spindle 20 is moved in the W-axis direction by the advancing/retracting drive motor 43 under the control of the W-axis position control section 94, the clamp device 44 is put into the clamping state, and then machining is performed at a desired feeding position.

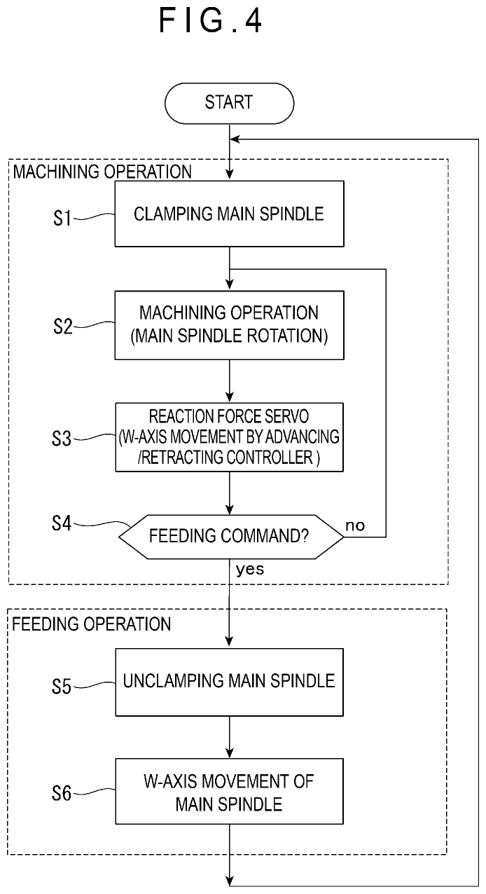

In a machining operation shown in FIG. 4, the clamp device 44 is switched to the clamping state by the clamp control section 95, so that the main spindle 20 is clamped by the clamp device 44 (step S1).

The machining operation is performed on a workpiece by performing the rotation and XYZ-axis movement of the main spindle 20 based on a command from the controller 9 with the main spindle 20 being clamped (step S2).

The reaction force against the advancing/retracting drive device 40 is detected by the reaction force sensor 45 when the main spindle 20 extends or contracts in thermal deformation during the machining operation. The reaction force servo control is performed by the reaction force servo control section 96 to inhibit unnecessary current from passing through the advancing/retracting drive motor 43 (step S3).

The controller 9 stops the machining operation upon detection of a W-axis movement command during the machining operation (steps S1 to S4), and executes a W-axis adjustment operation (main spindle feeding operation).

In the W-axis adjustment operation, the clamp device 44 is switched to the unclamping state by the clamp control section 95, so that the clamp device 44 releases the main spindle 20 (step S5).

With the main spindle 20 being unclamped, the W-axis position control section 94 controls the advancing/retracting drive motor 43 based on the W-axis movement command to advance the main spindle 20 to a designated W-axis position (step S6).

The controller 9 ends the W-axis adjustment operation when the main spindle 20 has a designated advanced state. Then, the controller 9 restarts the machining operation including the steps S1 to S4.

The exemplary embodiment provides the following effects.

In the exemplary embodiment, the clamp device 44 is put into the unclamped state by the clamp control section 95 of the feeding control section 93 (feeding controller), and then the W-axis position control section 94 of the feeding control section 93 (feeding controller) controls the advancing/retracting drive motor 43 of the advancing/retracting drive device 40 to move the main spindle 20 back and forth. The main spindle 20 is thus set at a desired feeding position (W-axis position). Subsequently, the clamp device 44 is switched to the clamping state, and machining is performed by rotating the main spindle 20.

In the feeding control section 93, the reaction force servo control section 96 monitors reaction force to be detected by the reaction force sensor 45 when the clamp device 44 is put into the clamping state before machining. In machining with the main spindle 20, the main spindle 20 extends or contracts in thermal deformation caused by heat, generating reaction force against the advancing/retracting drive device 40 that is stationary at a desired feeding position. The reaction force is detected by the reaction force sensor 45, and the feeding control section 93 moves the advancing/retracting drive device 40 in a direction in which the reaction force of the main spindle 20 becomes small. Accordingly, the thermal displacement of the main spindle 20 is offset regardless of its amount. This eliminates unnecessary drive of the advancing/retracting drive device 40 for canceling out the thermal displacement of the main spindle 20 as well as unnecessary current consumption and heat generation for driving the advancing/retracting drive device 40.

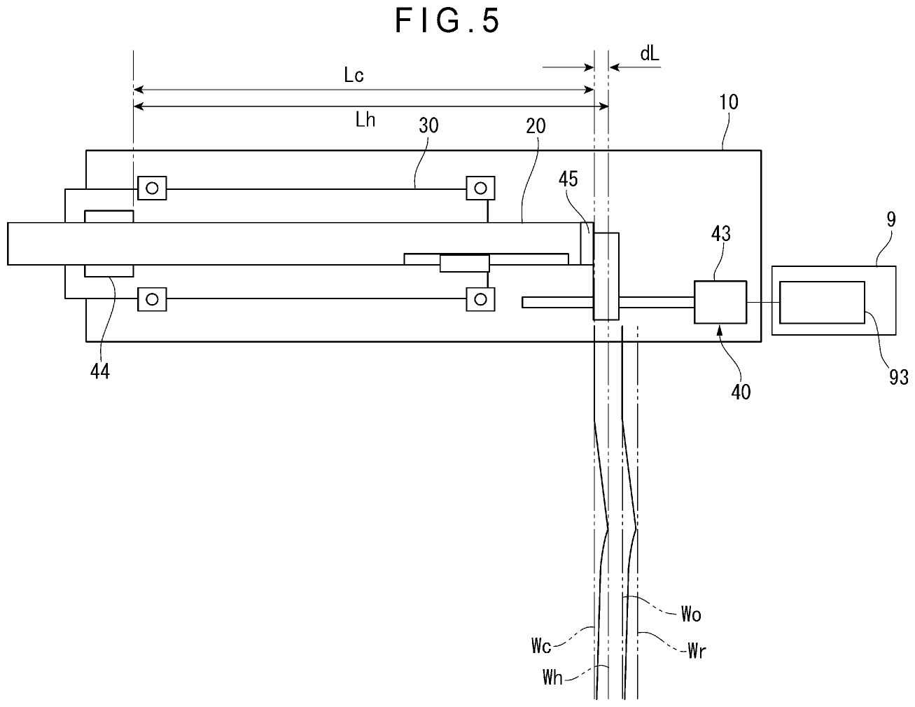

In FIG. 5, it is assumed that: the advancing/retracting drive device 40 is controlled under the position servo operation of the feeding control section 93 (feeding controller); the main spindle 20 in the unclamped state is set to have a desired feeding amount; and the main spindle 20 is clamped by the clamp device 44. Further, it is assumed that: the main spindle head body 10 has room temperature (low temperature); a length of the main spindle 20 from the clamp device 44 to a base end of the main spindle 20 is a length Lc; and a position of the base end of the main spindle 20 is a position Wc.

Furthermore, it is assumed that the machining operation generates operation heat to cause thermal expansion of the main spindle 20, resulting in thermal displacement dL at the base end of the main spindle 20. Under the above assumptions, a length of the main spindle 20 from the clamp device 44 to the base end of the main spindle 20 meets Lh=Lc+dL.

When the main spindle 20 is extended by an amount corresponding to the thermal displacement dL, the base end of the main spindle 20 is shifted and positioned at a position Wh. This causes the feeding control section 93 to detect, through the position servo of the W-axis position control section 94, that the base end of the main spindle 20 is shifted from the position We set in advance and positioned at the position Wh. Then, the feeding control section 93 drives the advancing/retracting drive motor 43 of the advancing/retracting drive device 40 to offset the thermal displacement dL. However, since the main spindle 20 is clamped, the base end of the main spindle 20 fails to return to the original position We even with the correction operation using the position servo of the W-axis position control section 94. This causes a situation in which drive current endlessly flows through the advancing/retracting drive motor 43 to result in further heat generation.

In contrast, in the feeding control section 93 according to the exemplary embodiment, the reaction force servo control section 96 performs reaction force servo control to move the advancing/retracting drive device 40 in a direction in which the reaction force of the main spindle 20 becomes small. That is, when the reaction force against the contact member 41 of the advancing/retracting drive device 40 increases by an amount corresponding to the thermal displacement dL of the main spindle 20, this reaction force is detected by the reaction force sensor 45. The reaction force servo control section 96 moves the contact member 41 in a direction in which the reaction force of the main spindle 20 detected becomes small (i.e., extension direction of the main spindle 20). Moving the contact member 41 from a position Wo to a position Wr (Wr−Wo=dL) eliminates the need for the correction using the position servo of the W-axis position control section 94. Thus, the drive current to the advancing/retracting drive motor 43 is stopped to generate no unnecessary heat generation and the like.

In the exemplary embodiment, a predetermined threshold value is provided in the reaction force servo control section 96 in advance, and the reaction force servo control is performed when the reaction force detected by the reaction force sensor 45 exceeds the threshold value.

This inhibits the reaction force servo control section 96 from being frequently activated when the thermal displacement of the main spindle 20 is small.

In the exemplary embodiment, the reaction force sensor 45 is a pressure sensor disposed at the second end of the main spindle 20 driven by a drive portion (contact member 41) of the advancing/retracting drive device 40. The reaction force generated between the main spindle 20 and the stationary advancing/retracting drive device 40 is thus reliably detected when the main spindle 20 extends or contracts in thermal displacement.

The invention is not limited to the above-described exemplary embodiment but includes modifications and the like as long as such modifications and the like are compatible with an object of the invention.

In the exemplary embodiment, the advancing/retracting control performed by the advancing/retracting drive device 40 under the control of the W-axis position control section 94 is the position servo operation using the position feedback of the main spindle 20 in which a detection angle of the encoder of the advancing/retracting drive motor 43 is referred to as position feedback and a current W-axis position is calculated in an incremental manner from an initial value. The invention, however, is not limited thereto. For example, position detection may be performed in an absolute manner using absolute coordinates, or the position feedback may be performed such that the position is detected at any position of the advancing/retracting drive device 40 or the main spindle 20.

In the exemplary embodiment, a predetermined threshold value is provided in the reaction force servo control section 96 in advance, and the reaction force servo control is performed when the reaction force detected by the reaction force sensor 45 exceeds the threshold value. The invention is not limited thereto, and the reaction force servo control section 96 may perform the reaction force servo control constantly.

In the exemplary embodiment, the reaction force sensor 45 is a pressure sensor disposed at the second end of the main spindle 20 driven by the contact member 41 of the advancing/retracting drive device 40. However, any other sensor may be used. For example, reaction force may be estimated from a strain gauge attached to a side surface of the main spindle 20, a strain gauge attached to the contact member 41, or a current value of the advancing/retracting drive motor 43.

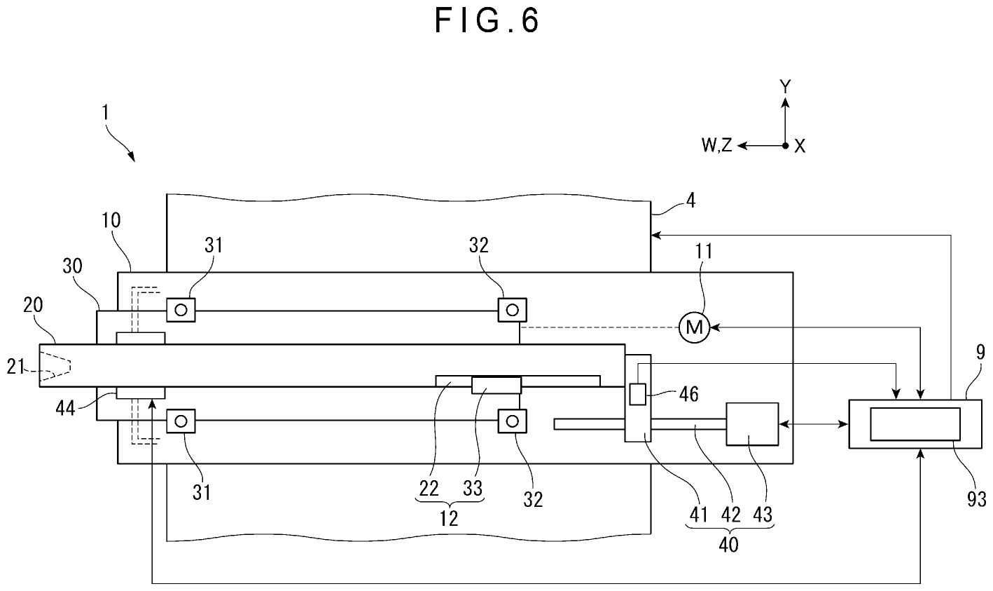

In another exemplary embodiment of the invention shown in FIG. 6, a strain gauge 46 is provided on a side surface of the contact member 41, which is the drive portion of the advancing/retracting drive device 40.

In such an exemplary embodiment, reaction force from the main spindle 20 can be detected based on a strain caused in the advancing/retracting drive device 40 when the main spindle 20 extends or contracts in thermal displacement. The strain gauge 46 is easily set up by being fixed to the side surface of the contact member 41. In particular, the structure using the strain gauge 46 is simpler than a structure where a sensor is provided in a mechanism part of the advancing/retracting drive device 40 and the main spindle 20.

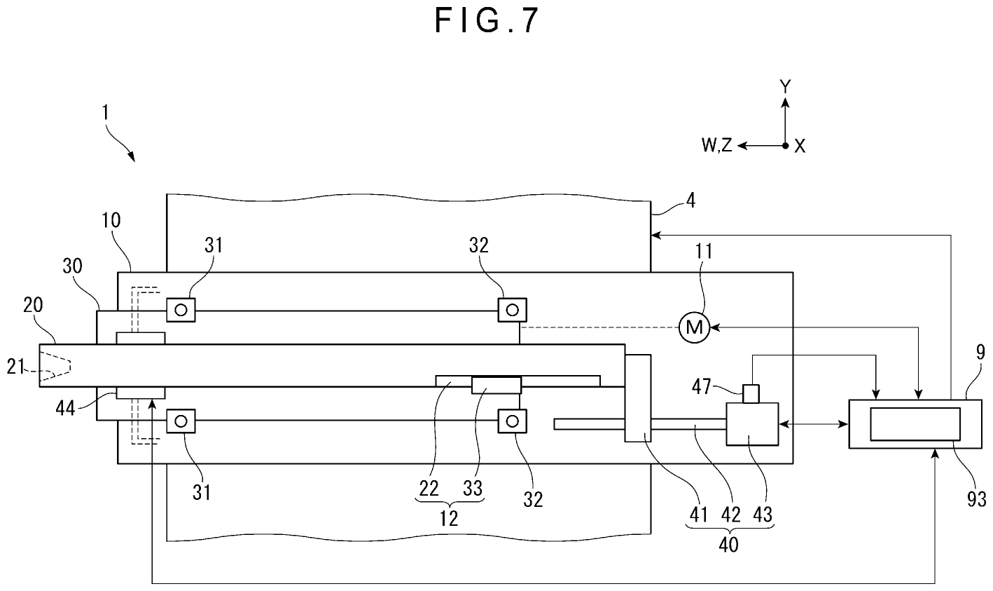

In still another exemplary embodiment of the invention shown in FIG. 7, a current sensor 47 is provided on the advancing/retracting drive motor 43 of the advancing/retracting drive device 40. The current sensor 47 detects a current value of the drive current when the advancing/retracting drive device 40 is driven to travel.

In such an exemplary embodiment, reaction force from the main spindle 20 can be detected based on an increase in a load on the advancing/retracting drive motor 43 and an increase in the drive current, which are caused by the reaction force between the main spindle 20 and the stationary advancing/retracting drive device 40 when the main spindle 20 extends or contracts in thermal displacement. The current sensor 47 is easily set up by being provided in a part of the advancing/retracting drive motor 43 or a part of a power cable connected to the advancing/retracting drive motor 43. In particular, the structure using the current sensor 47 is simpler than a structure where a sensor is provided in a mechanism part of the advancing/retracting drive device 40 and the main spindle 20.

1. A machine tool, comprising:
a main spindle comprising an end to which a tool is attachable, the main spindle being rotatable around a central axis;
a milling shaft housing the main spindle so that the main spindle is travelable back and forth in a direction of the central axis;
an advancing/retracting drive device configured to cause the main spindle to travel back and forth with respect to the milling shaft;
a clamp device provided in the milling shaft and configured to clamp the main spindle;
a feeding controller configured to control the advancing/retracting drive device and the clamp device; and
a reaction force sensor configured to detect reaction force against the advancing/retracting drive device from the main spindle, wherein
the feeding controller is configured to perform: in an unclamped state where the main spindle is not clamped by the clamp device, advancing/retracting control by which the main spindle is moved to a designated feeding position by the advancing/retracting drive device; and in a clamped state where the main spindle is clamped by the clamp device, reaction force servo control by which the advancing/retracting drive device is operated in a direction in which the reaction force detected by the reaction force sensor becomes small.

2. The machine tool according to claim 1, wherein
the reaction force sensor is a pressure sensor provided between a drive portion of the advancing/retracting drive device and a part of the main spindle driven by the drive portion.

3. The machine tool according to claim 2, wherein
the feeding controller is configured to perform the reaction force servo control in a case where the reaction force exceeds a predetermined threshold value.

4. The machine tool according to claim 1, wherein
the reaction force sensor is a strain gauge provided in a drive portion of the advancing/retracting drive device.

5. The machine tool according to claim 1, wherein
the reaction force sensor is a current sensor configured to detect a current value of an advancing/retracting drive motor of the advancing/retracting drive device.
